(19) United States
(12) Patent Application Publication
(10) Pub. No.: US 2026/0096576 A1
(43) Pub. Date: Apr. 9, 2026

(54) PLANT-BASED HEMATOPHAGOUS INSECT DIET AND METHODS OF USE

(71) Applicant: ADMINISTRATORS OF THE TULANE EDUCATIONAL FUND, New Orleans, LA (US)

(72) Inventors: Samuel Jameson, New Orleans, LA (US); Dawn Wesson, New Orleans, LA (US)

(21) Appl. No.: 19/113,069

(22) PCT Filed: Sep. 26, 2023
(86) PCT No.: PCT/US23/33691

§ 371 Date: Mar. 19, 2025

Related U.S. Application Data
(60) Provisional application No. 63/377,160, filed on Sep. 26, 2022.

(51) Int. Cl. A23K 20/147; A23J 1/00; A23J 1/14; A23K 10/16; A23K 10/30; A23K 20/163; A23K 20/179; A23K 20/22; A23K 40/10; A23K 50/90

(52) U.S. Cl. CPC A23K 20/147; A23J 1/009; A23J 1/14; A23K 10/16; A23K 10/30; A23K 20/163; A23K 20/179; A23K 20/22; A23K 40/10; A23K 50/90

(57) ABSTRACT

Disclosed herein is a plant-based, blood-free diet formulation for hematophagous insects comprising effective amounts of a plant-based protein source and, in some aspects, a carbohydrate source, wherein the plant-based, blood-free diet formulation is suitable for egg production and colony maintenance of hematophagous insects. In some aspects, such hematophagous insects include, but are not limited to, mosquitoes. In some aspects, the plant-based protein source is derived from hemp seeds. In some aspects, the protein source comprises additional proteins in addition to hemp protein. In some aspects, one or more additional proteins in the formulation is derived from spirulina, soybeans, chia seeds, quinoa, oats, nutritional yeast, and/or green peas.

### FIELD

This disclosure relates to maintenance and propagation of hematophagous insects including, but not limited to, mosquitoes. More specifically, a blood-free, plant-based diet formulation for mosquito colony production is disclosed.

### BACKGROUND

Many millions of people are infected and more than a million die each year from blood-borne illnesses transmitted by hematophagous insects including, but not limited to, mosquito-borne illnesses. Such mosquito-borne illnesses include, but are not limited to, malaria, dengue, filariasis, West Nile virus, Western/Eastern equine encephalitis, chikungunya virus, Zika virus, yellow fever, and the like.

The yellow fever mosquito (Aedes aegyptior Ae. aegyptl) is the predominant vector of several arboviral pathogens around the world that result in significant human morbidity and mortality. Aedes aegypti is known to transmit at least the dengue virus, yellow fever virus, chikungunya virus, and Zika virus. Consequently, the biology, ecology, and control of this species is widely studied. These studies require mosquito colonies that range in size from several hundred to several million mosquitoes. Adult female Ae. aegypti require a protein-dense meal, often blood, to develop eggs for the next generation.

Mosquitoes are divergent in host preference, which include humans, animals, birds, reptiles, and amphibians. They also vary in daily rhythms of blood feeding, such as, for example, diurnal, nocturnal, and crepuscular. In the laboratory, mosquito colonies are maintained mostly with a blood feeding system, where female mosquitoes are fed with vertebrate blood. Thus, laboratories maintaining mosquito colonies are dependent on live animals or animal blood. As a result, the production of large quantities of mosquitoes for mass-release in mosquito control trials places great pressure on animal care facilities and requires significant costs. The blood used for maintaining these mosquito colonies usually comes from live animals or birds, which are under constant surveillance and ethical regulations, requiring stringent animal care. This approach has certain drawbacks. While the diet is rich in protein, diets based on vertebrate blood are expensive, inconsistent in quality, and require pathogen-free certification. Additionally, blood-based diets are unstable during storage, and the blood must be maintained at 37° C.

Thus, the use of animal blood in mosquito rearing is a significant expense and raises biosafety and animal care and use concerns. Consequently, a laboratory maintaining only a small number of mosquito cages most likely spends thousands of dollars for the blood feeding arrangements which rely on use of animals for the blood. Understandably then, considerable research effort has been devoted to the development of artificial alternatives to blood or blood-based diets. In some labs, researchers use blood components or synthetic blood-free diets based on the host-seeking and blood-feeding behavior of mosquitoes.

Thus, there exists an unmet need for a commercially viable blood-free diet product that will replace costly, labor intensive and ethically vulnerable animal use for blood feeding in the mass rearing of blood feeding insects in the study of disease control.

### SUMMARY

Some of the main aspects of the disclosure are summarized below. Additional aspects are described in the other sections of this disclosure. The description in each section of this disclosure, regardless of any heading or sub-heading titles, is intended to be read in conjunction with all other sections. Furthermore, the various embodiments or aspects described in each section of this disclosure can be combined in various different ways, and all such combinations are intended to fall within the scope of the disclosure or the invention.

The present disclosure provides a blood-free-diet for feeding mosquitoes, wherein the diet or diet composition is able to support ovarian development, egg maturation and fertility, as well as low progeny larval mortality, and normal development of offspring into adult mosquitoes.

Provided herein is a blood-free, plant-derived diet composition for feeding a hematophagous insect, the composition comprising plant-derived protein, sodium chloride, and sodium bicarbonate. In some aspects, the composition further comprises sugar. In some aspects the sugar is a plant-derived sugar or it is a synthetic sugar. In some aspects, the composition further comprises one or more lipids. In some aspects, the composition further comprises a dye. In some aspects, the composition is animal protein free and/or does not comprise animal products. In some aspects, the composition is serum albumin free. In some aspects, the composition does not comprise any recombinant or bio-engineered ingredients. In some aspects, the plant-derived protein is obtained from hemp seeds. In some aspects, the plant-derived protein is obtained from hemp seeds and spirulina. In some aspects, the plant-derived protein is obtained from soybeans. In some aspects, the plant-derived protein comprises water-soluble albumin and/or edestin. In some aspects, the plant-derived protein further comprises protein obtained from an additional plant source. In some aspects, the additional plant source is soybeans, chia seeds, quinoa, oats, nutritional yeast, and/or green peas. In some aspects, the plant-derived sugar is sucrose, dextrose, fructose, or glucose, or a combination of any two or more thereof. In some aspects, the composition further comprises adenosine triphosphate. In some aspects, the composition further comprises a colorant or dye. In some aspects, the plant-derived protein is present in the composition at a concentration of about 60-200 mg/mL or about 6-20% (W/V). In some aspects, the sodium chloride is present in the composition at a concentration of about 0.005-1.0% (W/V) or at a concentration of about 10-190 mM. In some aspects, the sodium bicarbonate is present in the composition at a concentration of about 0.042 to 0.1% (W/V) or at a concentration of about 0.1-200 mM. In some aspects, the sugar is present in the composition at a concentration of about 0.1-5% (W/V) or at a concentration of about 3-150 mM. In some aspects, the hematophagous insect is a mosquito. In some aspects, the mosquito is of the species Aedes aegypti. In some aspects, the mosquito is of a laboratory mosquito colony. In some aspects, the composition is suitable for the growth and maintenance of one or more laboratory mosquito colonies. In some aspects, the composition is suitable for maintaining and/or propagating multiple generations of mosquitoes. In some aspects, the composition is produced, stored, and/or transported as a dried powder. In some aspects, the dried powder is a freeze-dried powder. In some aspects, the dried powder is a lyophilized powder. In some aspects, the freeze-dried powder is a lyophilized powder. In some aspects, the dried powder is reconstitutable with water at sufficient consistency for feeding a hematophagous insect. In some aspects, the dried powder and water are present in a ratio of about 1 to 5, respectively. In some aspects, the composition is fresh for immediate feeding of hematophagous insects. In some aspects, the composition is freeze dried for later feeding of hematophagous insects.

Also provided herein is a method of feeding a hematophagous insect, the method comprising providing an effective amount of the diet composition as described herein to the insect. In some aspects, providing the diet composition comprises use of a blood feeding device. In some aspects, the hematophagous insect is a mosquito. In some aspects, the mosquito is genetically modified. In some aspects, the mosquito is of the species Aedes aegypti. In some aspects, the mosquito is of a laboratory mosquito colony. In some aspects, the diet composition is sufficient to maintain a laboratory mosquito colony. In some aspects, the diet composition is sufficient for oocyte production. In some aspects, the diet composition is sufficient for synchronous egg production. In some aspects, the diet composition is sufficient to maintain hatch rates.

Also provided herein is a blood-free, animal protein-free, plant-derived diet composition for feeding a hematophagous insect. In some aspects, the composition comprises hemp seed protein at a concentration of about 60 to 200 mg/mL (about 6 to 20% (W/V)). In some aspects, the composition comprises hemp seed protein at a concentration of about 30 to 100 mg/mL (about 3 to 10% (W/V)) and spirulina protein at a concentration of about 30 to 100 mg/ml (about 3 to 10% (W/V)). In some aspects, the diet further comprises sodium chloride at a concentration of about 0.005 to 1.0% (W/V) or at a concentration of about 10-190 mM, and/or sodium bicarbonate at a concentration of about 0.042 to 0.1% (W/V) or at a concentration of about 0.1 mM-200 mM. In some aspects, the diet further comprises sugar at a concentration of about 0.1-5% (W/V) or at a concentration of about 3-150 mM.

The disclosure also provides a method of making an artificial, blood-free diet composition for feeding a hematophagous insect, the method comprising isolating protein from hemp seeds; and adding sodium chloride and/or sodium bicarbonate to the isolated protein. In some aspects, the method further comprises isolating protein from spirulina. In some aspects, the method further comprises isolating protein from another plant source. Thus, in some aspects the composition comprises protein from hemp seeds and protein from spirulina and/or another plant source. In some aspects, the method further comprises adding sugar to the composition. In some aspects, the isolating step comprises extracting water-soluble protein from the hemp seeds and obtaining the hemp milk. In some aspects, the hemp protein is precipitated from the hemp milk. In some aspects, the protein is dried first before adding sodium chloride and/or sodium bicarbonate to the protein. In some aspects, the diet composition comprises hemp seed protein at a concentration of about 60 to 200 mg/mL (about 6 to 20% (W/V)). In some aspects, the diet composition further comprises sodium chloride at a concentration of about 0.005 to 1.0% (W/V) or at a concentration of about 10-190 mM, and/or sodium bicarbonate at a concentration of about 0.042 to 0.1% (W/V) or at a concentration of about 0.1 mM-200 mM. In some aspects, the diet composition further comprises sugar at a concentration of about 0.1-5% (W/V) or at a concentration of about 3-150 mM. In some aspects, the method further comprises freeze-drying the composition.

Further aspects and advantages will be apparent to those of ordinary skill in the art from a review of the following detailed description, taken in conjunction with the drawings. While the compounds and methods disclosed herein are susceptible of embodiments or aspects in various forms, the description hereafter includes specific embodiments or aspects with the understanding that the disclosure is illustrative, and is not intended to limit the invention to the specific embodiments or aspects described herein. Various changes and modifications within the spirit and scope of the disclosure will become apparent to those skilled in the art from this detailed description.

### BRIEF DESCRIPTION OF THE DRAWINGS

FIG. 1 shows a plot of oocyte major axis length by days post-feed or post-meal ingestion in mosquitoes fed a blood meal or meal 8126 (hemp seed diet).

FIG. 2A-C shows coloration of meals in a test tube and in a mosquito after ingestion. FIG. 2A shows a hemp+spirulina meal (left tube, dark colored liquid) and a hemp-only meal (right tube, light colored liquid). FIG. 2B shows a mosquito fed with a hemp-only meal. FIG. 2C shows a mosquito fed with hemp+spirulina meal. The meal containing spirulina (i.e., hemp+spirulina) is easily visible in the abdomen of the mosquito in FIG. 2C due to its dark coloring because of the presence of spirulina in the meal.

FIG. 3 provides graphs of mean egg counts by meal type for a full data set (left panel) and for all non-zero data (right panel). The graphed bars indicate means. Error bars were plotted over jittered individual data points for each meal type. The left panel contains a full data set. The right panel contains all non-zero data. These data indicate that in the Hemp+Spirulina Meal group, the female mosquitoes who laid eggs are using protein from spirulina in addition to protein from hemp, and that the modest reduction in mean number of eggs per female is not from simple dilution of the control meal.

### DETAILED DESCRIPTION

Any headings or subheadings provided below, and throughout this disclosure, are not intended to denote limitations of the various embodiments or aspects of the disclosure, which are to be understood by reference to the specification as-a-whole. For example, this Detailed Description is intended to read in conjunction with, and to expand upon, the description provided in all other sections of this patent application, including the Summary and Examples sections thereof.

An object of the disclosure is to provide a blood-free, plant-based diet formulation for the maintenance and propagation of hematophagous insects including, but not limited to, mosquitoes. Additionally, the disclosure provides methods of maintaining and propagating hematophagous insects and methods of making the diet composition.

The disclosure includes a diet composition(s) for feeding hematophagous insects and arachnids. Hematophagy (also known as haematophagy or hematophagia) is the practice by certain animals of feeding on blood (from the Greek words aIpa haima “blood” and (payiv phagein “to eat”). Since blood is a fluid tissue rich in nutritious proteins and lipids that can be taken without great effort, hematophagy is a preferred form of feeding for many small animals, such as worms and arthropods. Some intestinal nematodes, such as Ancylostomatids, feed on blood extracted from the capillaries of the gut, and about 75 percent of all species of leeches (e.g., Hirudo medicinalis), a free-living worm, are hematophagous. Such insects and arachnids of medical importance for being hematophagous, at least in some species, include, but are not limited to, the sandfly, blackfly, tsetse fly, bedbug, assassin bug, mosquito, tick, louse, mite, midge, and flea.

In some aspects, the disclosure includes a diet for feeding mosquitoes. Like all flies, mosquitoes go through four stages in their life cycles: egg, larva, pupa, and adult or imago. The first three stages—egg, larva, and pupa—are largely aquatic. Each of the stages typically lasts 5 to 14 days, depending on the species and the ambient temperature, but there are important exceptions. Eggs hatch to become larvae, which grow until they are able to change into pupae. The adult mosquito emerges from the mature pupa as it floats at the water surface. Bloodsucking mosquitoes, depending on species, sex, and weather conditions, have potential adult lifespans ranging from as short as a week to as long as several months. Some species can overwinter as adults in diapause.

Mosquito habits of oviposition, the ways in which they lay their eggs, vary considerably between species, and the morphologies of the eggs vary accordingly. Females of many common species can lay 100-200 eggs during the course of the adult phase of their life cycles. Even with high egg and intergenerational mortality, over a period of several weeks, a single successful breeding pair can create a population of thousands. Aedes females generally drop their eggs singly but not as a rule into water. Instead, they lay their eggs on damp mud or other surfaces near the water's edge. Such an oviposition site commonly is the wall of a cavity such as a hollow stump or a container such as a bucket or a discarded vehicle tire. The eggs generally do not hatch until they are flooded, and they may have to withstand considerable desiccation before that happens. They are not resistant to desiccation straight after oviposition, but must develop to a suitable degree first. After that, they can enter diapause for several months if they dry out. Clutches of eggs of the majority of mosquito species hatch as soon as possible, and all the eggs in the clutch hatch at much the same time. In contrast, a batch of Aedes eggs in diapause tends to hatch irregularly over an extended period of time. This makes it much more difficult to control such species than those mosquitoes whose larvae can be killed all together as they hatch.

Larvae develop through four stages, or instars, after which they metamorphose into pupae. At the end of each instar, the larvae molt, shedding their skins to allow for further growth. The pupa can swim actively by flipping its abdomen, and it is commonly called a “tumbler” because of its swimming action. As with the larva, the pupa of most species must come to the surface frequently to breathe, which they do through a pair of respiratory trumpets on their cephalothoraxes. They do not feed during this stage. Typically they pass their time hanging from the surface of the water by their respiratory trumpets.

The period of development from egg to adult varies among species and is strongly influenced by ambient temperature. Some species of mosquitoes can develop from egg to adult in as few as five days, but a more typical period of development in tropical conditions would be some 40 days or more for most species. The variation of the body size in adult mosquitoes depends on the density of the larval population and food supply within the breeding water.

Males typically live for about 5-7 days, feeding on nectar and other sources of sugar. After obtaining a full blood meal, the female will rest for a few days while the blood is digested and eggs are developed. This process depends on the temperature, but usually takes two to three days in tropical conditions. Once the eggs are fully developed, the female lays them and resumes host-seeking. The cycle repeats itself until the female dies. While females can live longer than a month in captivity, most do not live longer than one to two weeks in nature. Their lifespans depend on temperature, humidity, and their ability to successfully obtain a blood meal while avoiding host defenses and predators.

In many species, the female needs to obtain nutrients from a blood meal before it can produce eggs, whereas in many other species, obtaining nutrients from a blood meal enables the mosquito to lay more eggs. Both plant materials and blood are useful sources of energy in the form of sugars, and blood also supplies more concentrated nutrients, such as protein and lipids, wherein the proteins are important for egg production and mosquito propagation.

Female mosquitoes typically hunt their blood host by detecting organic substances such as carbon dioxide (CO₂) and 1-octen-3-ol (mushroom alcohol, found in exhaled breath) produced from the host, and through visual recognition. Mosquitoes prefer some people over others.

Prior to and during blood feeding, blood-sucking mosquitoes inject saliva into the bodies of their source(s) of blood. This saliva serves as an anticoagulant; without it the female mosquito's proboscis might become clogged with blood clots. The saliva also is the main route by which mosquito physiology offers passenger pathogens access to the hosts' bloodstream. The salivary glands are a major target to most pathogens, whence they find their way into the host via the saliva.

The disclosure includes a plant-based, blood-free diet to feed all types of mosquitoes including, but not limited to, Aedes mosquitoes. Mosquitoes (or mosquitos) are members of a group of over 3,500 species of small flies within the family Culicidae (from the Latin culex meaning “gnat”). Mosquitoes have been classified into 112 genera, some of the more common of which are Aedeomyia, Aedes, Anopheles, Armigeres, Ayurakitia, Borachinda, Coquillettidia, Culex, Culiseta, Deinocerites, Eretmapodites, Ficalbia, Galindomyia, Haemagogus, Heizmannia, Hodgesia, Isostomyia, Johnbelkinia, Kimia, Limatus, Lutzia, Malaya, Mansonia, Maorigoeldia, Mimomyia, Onirion, Opifex, Orthopodomyia, Psorophora, Runchomyia, Sabethes, Shannoniana, Topomyia, Toxorhynchites, Trichoprosopon, Tripteroides, Udaya, Uranotaenia, Verrallina, and Wyeomyia. Thus, more than 3,000 species of mosquitoes are known to exist, with about 176 of these species present in North America. The most common mosquitoes in the U.S. are those of the Aedes, Culex, and Anopheles genera. Each has its own unique characteristic, and each has the potential to transmit various diseases. The disclosure includes all types of known mosquitoes and is not limited to a diet composition for the Aedes species or methods of feeding the Aedes species exemplified herein.

To study mosquitoes and mosquito-borne diseases, mosquito colonies are maintained and propagated in the laboratory. As used herein, “maintained” means contained in strain-specific colonies without the introduction of wild-type or external genetic variability. As used herein, “propagated” means the expansion or growth of a maintained colony such that the number of viable adults in each generation is greater than or equal to the number of viable adults in the prior generation.

Most vector mosquitoes are anautogenous which means that females require a vertebrate blood meal for egg production and development. A major bottleneck for establishing effective mosquito breeding in captivity is that production methods depend on a supply of blood from different animal sources and its quality is often variable. Some mosquito laboratory rearing strategies use as blood sources sedated or restrained live animals (mice, rats, chickens), human blood, or blood-based diet formulations. Nevertheless, foreseeing the urgent need to produce mosquitoes on a large scale, the use of large quantities of blood constitutes a drawback due to ethical concerns and logistical issues associated with demanding safety regulations.

In addition, the mass rearing of mosquitoes requires a specialized animal care facility, qualified personnel, and an efficient feeding system. These limitations have prompted the development of artificial diets capable of mimicking blood in terms of producing viable mosquito eggs. Artificial diets based on the rich nutrient content of human blood have shown to prompt female mosquito oogenesis and fertility in vivo with limited success in comparison to a standard vertebrate blood meal. Successful artificial diets for mosquitoes in the laboratory must attract the mosquitoes to eat the diet; provide nutrients to maintain the mosquito and allow vitellogenesis to occur; result in the production and/or laying of large egg batches; and be sufficient for the offspring to survive and thrive. The disclosure provides a blood-free, plant-based diet formulation for mosquito colony production to meet these diet requirements.

In some aspects, mosquitoes are maintained in a climate controlled insectary at 70-80% relative humidity and a 16-8 (day-night) light cycle using the following protocol. In some aspects, larval mosquitoes are reared in pans of water at a density of 1 larva per 5-10 mL. Larvae are fed commercially available sinking algae wafers marketed for aquarium fish (https-colon_forward slash_forward slash www.petco.com/shop/en/petcostore/product/hikari-tropical-algae-wafers-for-plecostomus-and-algae-eaters). Upon pupation, pupae are moved to a cup of clean water and allowed to emerge as adults within a cage. In some aspects, a diet of 5-10% sucrose in water is provided ad libitum to adult mosquitoes by means of a saturated cotton ball or wick. In some aspects, mesh panels on the sides of the cage allow for meals to be proffered from the outside of the cage with the mosquitoes feeding through the mesh siding. In some aspects, after feeding, a cup is added to the cage containing a small amount of water and damp seed germination paper, coffee filter, or other suitable substrate. 5-7 days after feeding the female mosquitoes lay their eggs onto the damp paper substrate where they can be collected, dried, and added to water to hatch the next generation. In various aspects, mosquitoes freely copulate. In some aspects, to promote fertilization, males are maintained within the colony with the females. In various aspects, mating tends to happen shortly after emergence and at or prior to the first blood meal, or as in the instant disclosure, on the blood-free diet composition as described herein. Females only need to mate once in their lifetime as they store the sperm in an organ that allows them to fertilize eggs just before depositing them.

The development of a successful blood-free diet that allows mass production of anautogenous mosquitoes without the need for costly animal care facilities or blood or plasma supply is thus a real need in research and medical fields.

The disclosure provides a plant-based, blood-free diet composition and methods of using the diet composition to feed, maintain, and grow populations of hematophagous insects. The diet composition promotes both survival and egg laying. The blood-free diet is suitable for production of multiple generations of hematophagous insects including, but not limited to, mosquitoes. The blood-free diet of the disclosure is also suitable for rearing mosquitoes under diapausing conditions and production of viable diapause eggs. Moreover, the diet is suitable for growth of a variety of different mosquito species including, but not limited to, Aedes aegypti (Ae. aegyptl) mosquitoes. Additionally, the blood-free diet of the disclosure, in various aspects, can be stored for longer periods of time than blood-based diets.

The disclosure provides a plant-based, blood-free diet to provide a reliable and consistent nutrition to adult mosquitoes that is able to mimic a standardized vertebrate blood meal. The plant-based, blood-free diet stimulates oogenesis and egg production and has a similar or superior effect on mosquito fitness relative to a standard vertebrate blood.

It has long been established that mosquito colonies, including but not limited to those comprising Aedes aegyptimosquitoes, can be maintained on protein-rich solutions, such as bovine serum albumin. One of the purposes of this disclosure was to develop a plant-based diet which offers an alternative to a blood-based diet, such as those comprising bovine serum albumin, for the feeding and propagation of mosquito colonies. To determine the ability of plant proteins to replace animal proteins in mosquito rearing, multiple plant sources and one algal source of complete protein were investigated. Non-blood-based protein diets are provided herein.

The protein source present in the blood-free diet formulation is a plant protein. Suitable protein sources include, but are not limited to, one or more of hemp or hemp seeds, spirulina, soybeans, chia seeds, quinoa, oats, nutritional yeast, and/or green peas. In one aspect, the protein source comprises or consists of hemp seed protein. In some aspects, the protein source comprises or consists of hemp seed protein and spirulina protein. In some aspects, the protein source comprises 50% hemp protein and 50% spirulina protein. In other aspects, however, a combination of two or more protein sources can be combined at various percentages to make a 100% protein.

In other aspects, the protein source comprises hemp seed protein and protein obtained from an additional plant source. In some aspects, the additional plant source is spirulina, soybeans, chia seeds, quinoa, oats, nutritional yeast, and/or green peas. In some aspects, the protein source is present in an amount of about 6-20% (W/V) or about 10-12% (W/V). In some aspects, the hemp protein source is present in an amount of about 3-10% (W/V) and one or more additional protein sources is present in an amount of about 3-10% (W/V). In some aspects, the hemp protein source is present in an amount of about 3-10% (W/V) and the spirulina protein source is present in an amount of about 3-10% (W/V). In some aspects, the hemp protein source is present in an amount of about 5% (W/V) and the spirulina protein source is present in an amount of about 5% (W/V). In some aspects, the protein source is present in the composition in an amount of about 3%, about 4%, about 5%, about 6%, about 7%, about 8%, about 9%, about 10%, about 11%, about 12%, about 13%, about 14%, about 15%, about 16%, about 17%, about 18%, about 19%, or about 20% (W/V). In some aspects, the protein source is present in the composition in an amount of about 6-20% (W/V) or about 10-12% (W/V).

In some aspects, the protein source is present in an amount of about 60-200 mg/mL or about 100-120 mg/mL. In some aspects, the protein source is present in the composition in an amount of about 60, about 70, about 80, about 90, about 100, about 110, about 120, about 130, about 140, about 150, about 160, about 170, about 180, about 190, or about 200 mg/mL. In some aspects, the hemp protein source is present in an amount of about 100 mg/ml or about 200 mg/mL. In some aspects, the hemp protein source is present in an amount of about 100 mg/ml and the other protein source is present in an amount of about 100 mg/mL. In some aspects, the hemp protein source is present in an amount of about 100 mg/ml and the spirulina protein source is present in an amount of about 100 mg/mL.

In some aspects, the blood-free diet formulation also comprises sodium chloride. In some aspects, the sodium chloride is present in the composition at a concentration of about 0.005-1.0% (W/V). Thus, in some aspects, the sodium chloride is present in the composition at a concentration of about 0.005%, about 0.01%, about 0.015%, about 0.02%, about 0.025%, about 0.03%, about 0.035%, about 0.04%, about 0.045%, about 0.05%, about 0.055%, about 0.06%, about 0.065%, about 0.07%, about 0.075%, about 0.08%, about 0.085%, about 0.09%, about 0.095%, or about 1.0% (W/V). In some aspects, the sodium chloride is present in the composition at a concentration of about 10-190 mM. Thus, in some aspects, the sodium chloride is present in the composition at a concentration of about 10 mM, about 20 mM, about 30 mM, about 40 mM, about 50 mM, about 60 mM, about 70 mM, about 80 mM, about 90 mM, about 100 mM, about 110 mM, about 120 mM, about 130 mM, about 140 mM, about 150 mM, about 160 mM, about 170 mM, about 180 mM, or about 190 mM.

In some aspects, the blood-free diet formulation also comprises sodium bicarbonate. In some aspects, the sodium chloride is present in the composition at a concentration of about 0.01-0.2% (W/V) or at a concentration of about 0.04-0.1% (W/V). In some aspects, the concentration is about 0.042-0.1% (W/V). Thus, in some aspects, the sodium bicarbonate is present in the composition at a concentration of about 0.01%, about 0.02%, about 0.03%, about 0.04%, about 0.05%, about 0.06%, about 0.07%, about 0.08%, about 0.09%, about 0.1%, about 0.11%, about 0.12%, about 0.13%, about 0.14%, about 0.15%, about 0.16%, about 0.17%, about 0.18%, about 0.19%, or about 0.2% (W/V). In some aspects, the sodium bicarbonate is present in the composition at a concentration of about 0.1-200 mM. Thus, in some aspects, the sodium bicarbonate is present in the composition at a concentration of about 0.1 mM, about 0.5 mM, about 1.0 mM, about 2.0 mM, about 3.0 mM, about 4.0 mM, about 5.0 mM, about 6.0 mM, about 7.0 mM, about 8.0 mM, about 9.0 mM, about 10 mM, about 20 mM, about 30 mM, about 40 mM, about 50 mM, about 60 mM, about 70 mM, about 80 mM, about 90 mM, about 100 mM, about 110 mM, about 120 mM, about 130 mM, about 140 mM, about 150 mM, about 160 mM, about 170 mM, about 180 mM, about 190 mM, or about 200 mM.

In some aspects, the blood-free diet formulation also comprises sugar. In some aspects, the sugar is any naturally-occurring or plant-derived sugar. In some aspects, the sugar is a synthetic sugar. In some aspects, the sugar is sucrose, dextrose, fructose, or glucose, or a combination of any two or more thereof. In some aspects, the sugar is present in the composition at a concentration of about 0.1-8% (W/V), at a concentration of about 1-5% (W/V), or at a concentration of about 0.5-4% (W/V). Thus, in some aspects, the sugar is present in the composition at a concentration of about 0.1%, about 0.2%, about 0.3%, about 0.4%, about 0.5%, about 0.6%, about 0.7%, about 0.8%, about 0.9%, about 1.0%, about 1.5%, about 2.0%, about 2.5%, about 3.0%, about 3.5%, about 4.0%, about 4.5%, about 5.0%, about 5.5%, about 6.0%, about 6.5%, about 7.0%, about 7.5%, or about 8.0 (W/V). In some aspects, the sugar is present in the composition at a concentration of about 0.1-250 mM. In some aspects, the sugar is present in the composition at a concentration of about 50 mM to about 110 mM. Thus, in some aspects, the sugar is present in the composition at a concentration of about 0.1 mM, about 0.5 mM, about 1.0 mM, about 2.0 mM, about 3.0 mM, about 4.0 mM, about 5.0 mM, about 6.0 mM, about 7.0 mM, about 8.0 mM, about 9.0 mM, about 10 mM, about 20 mM, about 30 mM, about 40 mM, about 50 mM, about 60 mM, about 70 mM, about 80 mM, about 90 mM, about 100 mM, about 110 mM, about 120 mM, about 130 mM, about 140 mM, about 150 mM, about 160 mM, about 170 mM, about 180 mM, about 190 mM, about 200 mM, about 210 mM, about 220 mM, about 230 mM, about 240 mM, or about 250 mM.

In some aspects, the blood-free diet formulation further comprises a lipid source, such as, for example, cholesterol. In another aspect, the blood-free diet formulation is free of a phagostimulant other than sugar. In some aspects, the blood-free diet formulation further comprises a traceable reagent or dye, such as a UV dye.

As used herein, the amounts shown in % (W/V) refer to the amount of solid component in g dissolved in mL of liquid. In each formulation above, a range of 5-20% (W/V) means a range between 5, 6, 7, 8, 9, 10, 11, 12, 13, 14, 15, 16, 17, 18, 19 and 20% (W/V). A range between 5-10% (W/V) refers to any of 5, 6, 7, 8, 9, and 10% (W/V). Notably, additional components may be added to the compositions or formulations above. These include, for example, other plant proteins, amino acids and lipids.

As used herein, an effective amount of the diet composition is an amount provided to sustain the desired effect. Thus, in the context of feeding insects, an effective amount is an amount required to maintain the insect and/or allow the insect to grow and reproduce. In some aspects, an effective amount is determined by an insectologist or entymologist who is familiar with the insect and its life cycle.

In some aspects, a crude hemp seed protein preparation is prepared for the diet composition from hemp seeds. In some aspects, water-soluble proteins are obtained by homogenization in water followed by filtration and centrifugation at 10,000 RCF for 30 minutes at 4° C. Stepwise precipitation of proteins is then carried out by the addition of solid ammonium sulfate. Proteins precipitating between 40%-70% saturation are then retained and resuspended in water. In some aspects, this solution is then dialyzed extensively against water at 4° C. using 6,000-8,000 MWCO membranes. The retentate is then flash frozen with liquid nitrogen and lyophilized. Once dried, crude hemp seed extract may be stored at 4° C. in airtight containers until needed or used immediately in the diet composition.

In some aspects, a spirulina protein preparation is prepared for the diet composition from spirulina. Water-soluble proteins from spirulina are obtained using the methods used for hemp seed preparations described herein above with minor modification. The precipitated protein fraction retained for spirulina is from about 10%-40% ammonium sulfate saturation.

In one aspect, a pea protein preparation is prepared. Water-soluble proteins from dried split peas are obtained using the methods used for hemp seed preparations with minor modification. The precipitated protein fraction retained for peas is from about 50%-100% ammonium sulfate saturation.

In some aspects of the disclosure, the plant-based diets are prepared by reconstituting crude plant proteins in distilled water at a concentration of 100 mg/mL (W/V). In some aspects, sodium chloride, sodium bicarbonate, and sucrose are added to final concentrations of about 120 mM, about 10 mM, and about 58.5 mM, respectively. These solutions are centrifuged at 10,000 RCF for 30 minutes, and the supernatant is retained, lyophilized, and stored at 4° C. in airtight containers until use. Prior to feeding, meals are reconstituted with distilled water to their original volume.

The plant-based, blood-free diet of the disclosure is a simple blood-free, animal protein-free diet and offers many advantages including, but not limited to, blood-free, animal protein-free, inexpensive, easy to store and feed, easy to scale-up, and supports both male and female development, reproduction, and survival.

In some aspects, hatch rate is measured. The hatch rate is the percentage of eggs laid that hatch into larvae. Hatch rate, in various instances, may be depressed for reasons, such as, unfertilized eggs, poor genetic fitness, and environmental conditions.

One of skill in the art will recognize that the various aspects and/or embodiments described throughout this disclosure can be combined in various different ways, and that such combinations are within the scope of the disclosure.

It is noted that as used herein, the singular forms “a”, “an”, and “the”, include plural references unless the context clearly indicates otherwise. Thus, for example, reference to “a nucleic acid” includes one or more of such different nucleic acids and reference to “the method” includes reference to equivalent steps and methods known to those of ordinary skill in the art that could be modified or substituted for the methods described herein.

Unless otherwise indicated, the term “at least” preceding a series of elements is to be understood to refer to every element in the series. Those skilled in the art will recognize, or be able to ascertain using no more than routine experimentation, many equivalents to the specific aspects or embodiments of the disclosure described herein. Such equivalents are intended to be encompassed by the disclosure.

The term “and/or” wherever used herein includes the meaning of “and”, “or” and “all or any other combination of the elements connected by said term.”

The term “about” or “approximately” as used herein means within 20%, preferably within 10%, and more preferably within 5% of a given value or range. It includes, however, also the concrete number, e.g., about 10 includes 10.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integer or step. When used herein the term “comprising” can be substituted with the term “containing” or “including” or sometimes when used herein with the term “having.”

When used herein, “consisting of” excludes any element, step, or ingredient not specified in the claim element. When used herein, “consisting essentially of” does not exclude materials or steps that do not materially affect the basic and novel characteristics of the claim.

In each instance herein any of the terms “comprising”, “consisting essentially of” and “consisting of” may be replaced with either of the other two terms.

It should be understood that this disclosure is not limited to the particular methodology, protocols, material, reagents, and substances, etc., described herein and as such can vary. The terminology used herein is for the purpose of describing particular aspects or embodiments only, and is not intended to limit the scope of the subject matter of the disclosure, which is defined solely by the claims.

All publications and patents cited throughout the text of this specification (including all patents, patent applications, scientific publications, manufacturer's specifications, instructions, etc.), whether supra or infra, are hereby incorporated by reference in their entirety. To the extent the material incorporated by reference contradicts or is inconsistent with this specification, the specification will supersede any such material.

A better understanding of the disclosure and of its advantages will be obtained from the following examples, offered for illustrative purposes only. The examples are not intended to limit the scope of the disclosure.

### EXAMPLES

Aspects and/or embodiments of the disclosure are illustrated by the following examples.

### Example 1

### Materials and Methods

It has long been established that mosquito colonies, including but not limited to those comprising Aedes aegypti (Ae. aegyptl) mosquitoes, can be maintained on protein-rich solutions, such as bovine serum albumin. One of the purposes of this disclosure was to develop a plant-based diet which offers an alternative to a blood-based diet, such as those comprising bovine serum albumin, for the feeding and propagation of mosquito colonies. To determine the ability of plant proteins to replace animal proteins in mosquito rearing, multiple plant sources and one algal source of complete protein were investigated. Non-blood-based protein diets were prepared as described herein below.

Crude hemp seed protein preparation: Organic defatted hulled hemp seed were purchased in bulk from a commercial supplier (Minnesota Hemp Farms, Hastings, MN). Water-soluble proteins were obtained by homogenization in water followed by filtration and centrifugation at 10,000 RCF for 30 minutes at 4° C. Stepwise precipitation of proteins was carried out by the addition of solid ammonium sulfate. Proteins precipitating between 40%-70% saturation were retained and resuspended in water. This solution was dialyzed extensively against water at 4° C. using 6,000-8,000 MWCO membranes. The retentate was flash frozen with liquid nitrogen and lyophilized. Once dried, crude hemp seed extract was stored at 4° C. in airtight containers until needed.

Crude pea protein preparation: Water-soluble proteins from organic dried split peas were obtained using the methods used for hemp seed preparations with minor modification. The precipitated protein fraction retained for peas was from 50%-100% ammonium sulfate saturation.

Artificial diet preparation: Plant-based diets were prepared by reconstituting crude plant proteins in distilled water at a concentration of 100 mg/mL (w/v). Sodium chloride, sodium bicarbonate, and sucrose were added to final concentrations of about 120 mM, about 10 mM, and about 58.5 mM, respectively. These solutions were centrifuged at 10,000 RCF for 30 minutes, and the supernatant was retained, lyophilized, and stored at 4° C. in airtight containers until use. Prior to feeding, meals were reconstituted with distilled water to their original volume.

Mosquito colonies: Aedes aegyptimosquitoes were maintained and are currently maintained in a climate controlled insectary at 70-80% relative humidity and a 16-8 (day-night) light cycle using the following protocol. Larval mosquitoes are reared in pans of water at a density of 1 larva per 5-10 mL. Larvae are fed commercially available sinking algae wafers marketed for aquarium fish, for example, Hikari Tropical Algae Wafers for Plecostomus & Algae Eaters (Petco; https-colon_forward slash_forward slash www.petco.com/shop/en/petcostore/product/hikari-tropical-algae-wafers-for-plecostomus-and-algae-eaters-110140?store_code=1431 &mr:device=c&mr:adType=local&cm_mmc=PSH %7cGGL %7cCA L%7cSBU05%7cSH14%7c0%7coZ4AgFePb8PMQF6cfeZNnh%7c58700007475749834%7c PRODUCT_GROUP%7c0%7c0%7cpla-1457221079415%7c127865324094%7c15104991825&gclid=CjwKCAjwm8WZBhBUEiwA17 8UnOc9AlDa6EWRkc4eFmKnjyj5VPtGiXvGpb99JDoxMbcQ_0797huApxoCbNwQAvD_Bw E&gclsrc=aw.ds). Upon pupation, pupae are moved to a cup of clean water and allowed to emerge as adults within a cage. This cage may vary in size but allows for access to the colony through a length of mesh or cloth tied closed on one side. A diet of 5-10% sucrose in water is provided ad libitum to adult mosquitoes by means of a saturated cotton ball or wick. Mesh panels on the sides of the cage allow for meals to be proffered from the outside of the cage with the mosquitoes feeding through the mesh siding. After feeding, a cup is added to the cage containing a small amount of water and damp seed germination paper, coffee filter, or other suitable substrate. 5-7 days after feeding the female mosquitoes lay their eggs onto the damp paper substrate where they can be collected, dried, and added to water to hatch the next generation.

Aedes aegyptimosquitoes freely copulate in the lab. To promote fertilization, males are maintained within the colony with the females. Mating tends to happen shortly after emergence and at or prior to the first blood meal, or as in the instant disclosure, at or prior to the blood-free diet composition as described herein. Females only need to mate once in their lifetime as they store the sperm in an organ that allows them to fertilize eggs just before depositing them.

### Example 2

### Mosquito Colonies and Feeding

Mosquito colonies and feeding: Mosquito rearing conditions including larva diet. Aedes aegypti(Ae. aegypti) (Rockefeller) mosquito colonies were proffered plant-based meals in a Rutledge-style water jacketed membrane feeder fitted with a ParafilmM membrane and maintained at 37° C. Meals were proffered for 2 hours.

Triplicate hatch rate trials: Three cages of greater than 100 female Ae. aegypti mosquitoes were offered the plant-based diet meals, as described herein above, and followed to assess number of eggs laid, hatch rate, larval mortality, and pupal mortality. Each cage was allowed seven days for oviposition on seed germination paper. Egg papers were dried over saturated sodium chloride and hatched under vacuum twelve days after feeding. The drying and hatching process was repeated seven days later to ensure complete hatching.

Pea protein-based meal: While colonies offered a pea protein-based meal readily fed to repletion, no eggs were obtained in triplicate trials.

Hemp seed-based meal: Colonies offered the hemp seed-based meal (“Meal 8126” or “8126”, as designated herein) reliably produced synchronous egg batches and this meal was selected for further study.

Hatch rate trials: Feeding was highly variable among the test cages (mean egg count n=161, std. err 125.1). On average, 2.01% (std. err=1.058) of the larvae did not survive to the pupal stage, and the average pupal mortality was found to be 0.017% (std. err=0.17). The overall average hatch rate was 75.44% (std. err.=16.65).

Because the hemp seed-based meal allowed for egg production, this hemp-seed based diet (i.e., Meal 8126) was used in subsequent experiments.

### Example 3

### Protein-Free Diet Sustained Hatch Rate

To determine how the hemp-derived meal affected hatch rate, three independent hatch rate trials were undertaken. Ae. aegypti (Rockefeller strain) colonies were fed with 8126 and allowed to lay eggs. The eggs were dried and incubated following standard protocols for 2 weeks prior to hatching. Three trials were carried out, and these trials resulted in an average hatch rate of 75.84% (Table 1).

TABLE 1
Hatch Rate of Mosquitoes Fed Hemp-Based Diet.

| Trial | Eggs | Number | Hatch |
|---|---|---|---|
| Number | Hatched | of Larvae | Rate |
| Trial 1 | 46 | 41 | 91.51% |
| Trial 2 | 411 | 390 | 75.44% |
| Trial 3 | 104 | 63 | 60.58% |

Trial 3 contained an artificial dye that Trial 1 and Trial 2 did not, which may have negatively affected the hatch rate. Published hatch rates for this strain of mosquito in the laboratory typically average 80-90%. See Farnesi et al. (2009), Embryonic development of Aedes aegypti(Diptera: Culicidae): Influence of different constant temperatures. Memórias do Instituto Oswaldo Cruz, 104(1), 124-126; and Mebrahtu et al. (1997), Inheritance of larval resistance to permethrin in Aedes aegypti and association with sex ratio distortion and life history variation. Am J Trop Med Hyg. Apr; 56(4):456-65. doi: 10.4269/ajtmh.1997.56.456. PMID: 9158058. The average hatch rate falls within the range of typical but may be improved with further optimization of nutritional balance in the diet.

### Example 4

### Oocyte Development in Mosquitoes Fed Different Diets

The development of eggs in a laboratory strain of Ae. aegyptimosquitoes fed on Meal 8126 were compared to those from mosquitoes fed on bovine blood (defibrinated bovine blood) (Hemostat Laboratories, Dixon, CA). The defibrinated bovine blood is used for comparisons and routine maintenance.

The mosquito stocks used for the trial all came from the same laboratory colony and were all reared to adulthood following the same standard laboratory procedures. Each generation, the mosquitoes were randomly assigned to several cages. One of each of these cages was randomly drawn for feeding with either blood or Meal 8126. Neither cage had previously fed on blood.

Meals were offered in the same format: 5 mL of meal (either defibrinated bovine blood or Meal 8126) was added to a glass membrane feeding apparatus covered with Parafilm M. In both cases, the feeder was attached to a circulating water bath set to 37° C. The cages were allowed to feed for 1 hour. Engorged mosquitoes were separated, and a random female was removed daily beginning at 24 hours post-feed for dissection. The ovaries were removed and placed on a microscope slide and allowed to dry. Images were taken with a dedicated digital microscope-mounted camera. For each time point and meal, 10 developing oocytes were randomly selected, and the longest axis of the cell was measured using the camera's PC software.

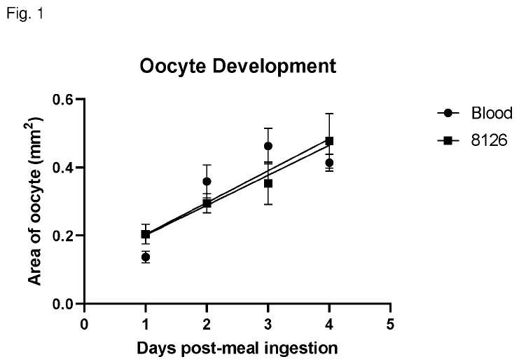

The results of these counts are plotted in FIG. 1 (Oocyte Development), and the summary data and statistics of oocyte measurements by day and meal is presented in Table 2.

TABLE 2
Oocyte Size.

| Group | Day | Count | Mean | SD |
|---|---|---|---|---|
| 8126 | 1 | 10 | 0.204 | 0.0291 |
| 8126 | 2 | 10 | 0.295 | 0.0284 |
| 8126 | 3 | 10 | 0.354 | 0.0622 |
| 8126 | 4 | 10 | 0.478 | 0.0801 |
| Blood | 1 | 10 | 0.137 | 0.0170 |
| Blood | 2 | 10 | 0.359 | 0.0489 |
| Blood | 3 | 10 | 0.463 | 0.0523 |
| Blood | 4 | 10 | 0.414 | 0.0255 |

To test whether there was a statistical difference between the two meals (either defibrinated bovine blood or Meal 8126) at each day's measurement, a 2-way analysis of variance (ANOVA) test was performed in R version 4.1.2. Repeated measures statistics were not used as each ovary was from a separate, randomly drawn mosquito and any mosquito-to-mosquito variations are assumed to be random and normally distributed. The ANOVA found that there was no statistically significant difference among the means of the meal types. As expected, the number of days post-feeding did have a significant effect on oocyte size (see Table 3 and FIG. 1). In Table 3, a 2-way ANOVA was carried out. *** designates statistical significance <0.001.

TABLE 3
Summary Data of Oocyte Measurements.

| | | | | | | Signif- |
|---|---|---|---|---|---|---|
| | Df | Sum Sq | Mean Sq | F Value | Pr (>F) | icance |
| Group (i.e., | 1 | 0.0022 | 0.00220 | 0.585 | 0.447 | |
| meal type) | | | | | | |
| Day post-feed | 3 | 0.8962 | 0.29874 | 79.272 | <2e−16 | *** |
| Residuals | 75 | 0.2826 | 0.00377 | | | |

The colony was successfully maintained through F5. A second colony was started from a small number of hemp seed-based meal fed females (n=3). This colony is in the F2 generation currently with a reproductive #>1 at each generation.

To date, meals reconstituted from their powdered form up to 8 months after preparation have functioned as expected. This hemp seed protein-based adult meal does not contain nor require adenosine triphosphate (ATP) or similar phagostimulants. ATP and analogues or derivatives thereof degrade significantly upon use or storage as they are innately unstable molecules. Typically, they must be maintained at −20° C. or colder to preserve their activity. Additionally, compounds in this group are prohibitively expensive. Their inclusion at relevant concentrations in an artificial diet would render that diet more expensive than commercially available animal blood alternatives. Consequently, for shipping, storage, and cost considerations, it is attractive to not use any of these compounds. Thus, the hemp seed protein-based adult meal of the disclosure serves as a cost-effective, non-biohazardous replacement for blood in laboratory and mass rearing settings.

The hemp seed protein-based adult meal was found to be palatable to Ae. aegypti and nutritionally sufficient to produce synchronous egg development and deposition at a rate high enough to maintain a colony for at least five generations. This meal preparation can be prepared fresh or as a stable dry powder and reconstituted with water at the time of feeding.

### Example 5

### Oocyte Development in Mosquitoes Fed a Diet Comprising Spirulina and Hemp

The development of eggs in a laboratory strain of Ae. aegyptimosquitoes fed on a diet comprising 50% spirulina protein and 50% hemp protein was compared in the same strain of mosquitoes fed a diet comprising 100% hemp protein.

Commercial spirulina powder was processed similarly to the hemp seeds to yield a freeze-dried soluble protein powder. The concentration of ammonium sulfate used to precipitate the desired proteins was determined empirically by preparing samples from 0-100% saturation and visualizing the soluble proteins via reducing and native SDS-PAGE gels.

Briefly, 6 grams of spirulina powder were suspended in distilled water and brought to 10% saturation with ammonium sulfate and centrifuged at 10,000× gravity, the supernatant being retained. The supernatant was brought to 40% saturation with ammonium sulfate and centrifuged at 10,000× gravity. The pellet was retained and resuspended in distilled water and dialyzed extensively against tap water at 4° C. The resulting liquid was snap frozen and lyophilized for use.

A meal comprising 50% spirulina protein and 50% hemp protein was prepared and fed to a random subset of an Aedes aegypti colony alongside a control meal of 100% hemp protein. The two meals (i.e., (1) 50% spirulina protein and 50% hemp protein and (2) a control meal of 100% hemp protein) were formulated as in Table 4.

TABLE 4
Formulation of Hemp-Only and Hemp + Spirulina Meals.

| | | | Hemp-Only | | Hemp + | |
|---|---|---|---|---|---|---|
| Ingredient | Concentration | | Meal | | Spirulina Meal | |
| Hemp proteins | wt % | | 500 | mg | 250 | mg |
| Spirulina proteins | wt % | | 0 | mg | 250 | mg |
| Sodium chloride | 140 | mM | 41 | mg | 41 | mg |
| Sodium bicarbonate | 25 | mM | 11 | mg | 11 | mg |
| Sucrose | 58.5 | mM | 100 | mg | 100 | mg |
| Dextrose | 3.5 | mM | 3.2 | mg | 3.2 | mg |
| Water | n/a | | Balance | | Balance | |
| Total Volume | | | 5 | mL | 5 | mL |

Meals were simultaneously offered to two cages of Ae. aegypti (Rockefeller) in water jacketed (37° C.) glass membrane feeders with Parafilm M membranes, and mosquitoes were allowed to feed for 1 hour.

After 1 hour, 15 engorged females were removed from each test cage and housed individually with a small cup of water and paper suitable for egg collection. Each individual cage was provided with 10% sucrose ad libitum from a cotton ball, and individuals were allowed 4 days to lay eggs.

Papers containing eggs were removed and counted. The raw egg counts are provided in Table 5.

TABLE 4
Egg Counts after Hemp-Only or Hemp + Spirulina Meal.

| Hemp-Only | Egg | Hemp + | Egg |
|---|---|---|---|
| Meal | Count | Spirulina Meal | Count |
| 1 | 22 | 1 | 0 |
| 2 | 0 | 2 | 0 |
| 3 | 0 | 3 | 10 |
| 4 | 3 | 4 | 16 |
| 5 | 7 | 5 | 0 |
| 6 | 14 | 6 | 0 |
| 7 | 14 | 7 | 15 |
| 8 | 13 | 8 | 0 |
| 9 | 0 | 9 | 18 |
| 10 | 0 | 10 | 0 |
| 11 | 33 | 11 | 9 |
| 12 | 33 | 12 | 20 |
| 13 | 25 | 13 | 0 |
| 14 | 27 | 14 | 10 |
| 15 | 10 | 15 | 0 |

TABLE 5
Summary of Egg Counts after Hemp-
Only or Hemp + Spirulina Meal.

| | Hemp-Only | Hemp + |
|---|---|---|
| | Meal | Spirulina Meal |
| Non-zero range of eggs laid | 3-33 | 9-20 |
| Total number of eggs | 201 | 98 |
| Average eggs per female | 13.4 | 6.53 |
| Average eggs per female laying eggs | 18.27 | 14 |
| Total number laying no eggs | 4 | 8 |

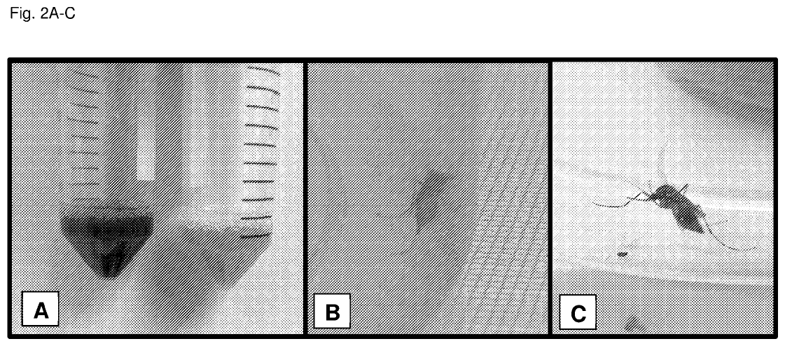

Both meals produce synchronous eggs in a normal time course in this mosquito species. The meal containing spirulina has the added benefits of reduced cost in raw materials and the ability to better visualize when a mosquito has fed (FIG. 2A-C) because spirulina provides a dark color. FIG. 2A shows a hemp+spirulina meal (left tube) and a hemp-only meal (right tube). FIG. 2B shows a mosquito fed with a hemp-only meal. FIG. 20 shows a mosquito fed with hemp+spirulina meal. The meal containing spirulina (i.e., hemp+spirulina) is easily visible in the abdomen of the mosquito due to its dark coloring because of the presence of spirulina in the meal.

A periodic confounding factor in studies where the meal lacks color is that it is difficult, if not impossible, to distinguish between the hemp-only meal a female who has ingested a large amount of sugar-water. Colonies are maintained with sucrose solutions and allowed to feed freely. The Hemp-Only Meal is visually indistinguishable from a sugar solution meal when handling and sorting the mosquitoes.

It is clear from the data, where females laying no eggs are removed, that the Hemp+Spirulina Meal functions in a way that is not simply diluting the Hemp-Only Meal—as would be indicated from the total egg counts (98 vs. 201, respectively; see Table 5). The hemp+spirulina meal resulted in a much narrower range of eggs per female deposited and only a marginally lower mean number of eggs per female laying eggs (14 vs. 18.27; see Table 5).

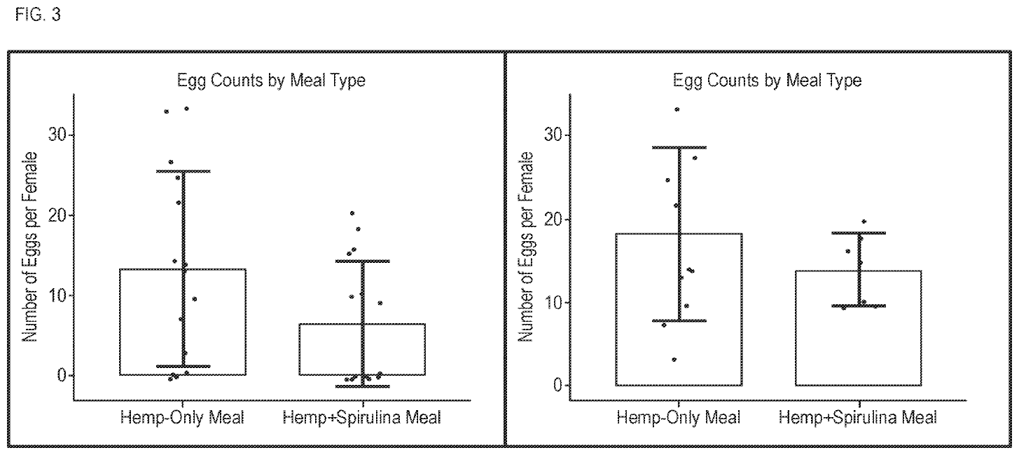

FIG. 3 shows graphs of mean egg counts by meal type for a full data set (left panel) and for all non-zero data (right panel). These data indicate that in the Hemp+Spirulina Meal group, the female mosquitoes who laid eggs are using protein from spirulina in addition to protein from hemp, and that the modest reduction in mean number of eggs per female is not from simple dilution of the control meal. Mosquitoes in the Hemp+Spirulina Meal group who laid eggs laid a more consistent number of eggs per female than Hemp-Only Meal controls. This experiment demonstrates that alternate protein sources may be incorporated with the hemp proteins to improve meal characteristics such as coloration or production costs.

Taken together, this study demonstrates that other non-animal complete protein sources (i.e., spirulina) may be included in the meal. However, egg production is abrogated when the hemp proteins are removed entirely from the meal, and the lower limit has not been established. However, a 50% replacement in protein content (weight) as demonstrated here in this Example is significant replacement while still allowing for egg production.

Thus, this study shows that the Hemp+Spirulina Meal is a nutritionally sufficient diet option for feeding hematophagous insects to produce synchronous egg development and deposition.

The foregoing description is given for clearness of understanding only, and no unnecessary limitations should be understood therefrom, as modifications within the scope of the invention may be apparent to those having ordinary skill in the art.

Throughout this specification and the claims which follow, unless the context requires otherwise, the word “comprise” and variations such as “comprises” and “comprising” will be understood to imply the inclusion of a stated integer or step or group of integers or steps but not the exclusion of any other integer or step or group of integers or steps.

Throughout the specification, where compositions are described as including components or materials, it is contemplated that the compositions can also consist essentially of, or consist of, any combination of the recited components or materials, unless described otherwise. Likewise, where methods are described as including particular steps, it is contemplated that the methods can also consist essentially of, or consist of, any combination of the recited steps, unless described otherwise. The invention illustratively disclosed herein suitably may be practiced in the absence of any element or step which is not specifically disclosed herein.

The practice of a method disclosed herein, and individual steps thereof, can be performed manually and/or with the aid of or automation provided by electronic equipment. Although processes have been described with reference to particular aspects or embodiments, a person of ordinary skill in the art will readily appreciate that other ways of performing the acts associated with the methods may be used. For example, the order of various of the steps may be changed without departing from the scope or spirit of the method, unless described otherwise. In addition, some of the individual steps can be combined, omitted, or further subdivided into additional steps.

All patents, publications and references cited herein are hereby fully incorporated by reference. In case of conflict between the present disclosure and incorporated patents, publications and references, the present disclosure should control.

### REFERENCES

P. H. Kogan, Substitute Blood Meal for Investigating and Maintaining Aedes aegypti(Diptera: Culicidae), Journal of Medical Entomology, Volume 27, Issue 4, 1 Jul. 1990, Pages 709-712, https://doi.org/10.1093/jmedent/27.4.709
P. H. Kogan, Substitute Blood Meal for Investigating and Maintaining Aedes aegypti(Diptera: Culicidae), Journal of Medical Entomology, Volume 27, Issue 4, 1 Jul. 1990, Pages 709-712, https://doi.org/10.1093/jmedent/27.4.709
Galun, R. A. C. H. E. L. (1967). Feeding stimuli and artificial feeding. Bulletin of the World Health Organization, 36(4), 590.

We claim:

1. A blood-free, plant-derived diet composition for feeding a hematophagous insect, the composition comprising:
a) plant-derived protein;
b) sodium chloride; and
c) sodium bicarbonate.

2. The composition of claim 1 further comprising sugar.

3. The composition of claim 2, wherein the sugar is a plant-derived sugar.

4. The composition of any one of claims 1-3, wherein the composition is animal protein free and/or does not comprise animal products.

5. The composition of any one of claims 1-4, wherein the composition is serum albumin free.

6. The composition of any one of claims 1-5, wherein the composition does not comprise any recombinant or bio-engineered ingredients.

7. The composition of any one of claims 1-6, wherein the plant-derived protein is obtained from hemp seeds.

8. The composition of any one of claims 1-6, wherein the plant-derived protein is obtained from hemp seeds and spirulina.

9. The composition of any one of claims 1-6, wherein the plant-derived protein is obtained from soybeans.

10. The composition of any one of claims 1-9, wherein the plant-derived protein comprises water-soluble albumin and/or edestin.

11. The composition of any one of claims 1-10, wherein the plant-derived protein further comprises protein obtained from an additional plant source.

12. The composition of claim 11, wherein the additional plant source is soybeans, chia seeds, quinoa, oats, nutritional yeast, and/or green peas.

13. The composition of any one of claims 2-12, wherein the plant-derived sugar is sucrose, dextrose, fructose, or glucose, or a combination of any two or more thereof.

14. The composition of any one of claims 1-13 further comprising adenosine triphosphate.

15. The composition of any one of claims 1-14 further comprising a colorant.

16. The composition of any one of claims 1-15, wherein the plant-derived protein is present in the composition at a concentration of about 60-200 mg/mL or about 6-20% (W/V).

17. The composition of any one of claims 1-16, wherein the sodium chloride is present in the composition at a concentration of about 0.005-1.0% (W/V) or at a concentration of about 10-190 mM.

18. The composition of any one of claims 1-17, wherein the sodium bicarbonate is present in the composition at a concentration of about 0.042 to 0.1% (W/V) or at a concentration of about 0.1-200 mM.

19. The composition of any one of claims 2-18, wherein the sugar is present in the composition at a concentration of about 0.1-5% (W/V) or at a concentration of about 3-150 mM.

20. The composition of any one of claims 1-19, wherein the hematophagous insect is a mosquito.

21. The composition of any one of claims 1-20, wherein the mosquito is of the species Aedes aegypti.

22. The composition of any one of claims 1-21, wherein the mosquito is of a laboratory mosquito colony.

23. The composition of any one of claims 1-22, wherein the composition is suitable for the growth and maintenance of one or more laboratory mosquito colonies.

24. The composition of any one of claims 1-23, wherein the composition is suitable for maintaining and/or propagating multiple generations of mosquitoes.

25. The composition of any one of claims 1-24, wherein the composition is produced, stored, and/or transported as a dried powder.

26. The composition of claim 25, wherein the dried powder is reconstitutable with water at sufficient consistency for feeding a hematophagous insect.

27. The composition of claim 26, wherein the dried powder and water are present in a ratio of about 1 to 5, respectively.

28. The composition of any one of claims 1-27, wherein the composition is fresh for immediate feeding of hematophagous insects.

29. The composition of any one of claims 1-27, wherein the composition is freeze dried for later feeding of hematophagous insects.

30. A method of feeding a hematophagous insect, the method comprising providing an effective amount of the diet composition of any one of claims 1-29 to the insect.

31. The method of claim 30, wherein providing the diet composition comprises use of a blood feeding device.

32. The method of 30 or 31, wherein the hematophagous insect is a mosquito.

33. The method of claim 32, wherein the mosquito is genetically modified.

34. The method of claim 32 or 33, wherein the mosquito is of the species Aedes aegypti.

35. The method of any one of claims 32-34, wherein the mosquito is of a laboratory mosquito colony.

36. The method of any one of claims 30-35, wherein the diet composition is sufficient to maintain a laboratory mosquito colony.

37. The method of any one of claims 30-35, wherein the diet composition is sufficient for oocyte production.

38. The method of any one of claims 30-35, wherein the diet composition is sufficient for synchronous egg production.

39. The method of any one of claims 30-37, wherein the diet composition is sufficient to maintain hatch rates.

40. A blood-free, animal protein-free, plant-derived diet composition for feeding a hematophagous insect, the composition comprising hemp seed protein at a concentration of about 60 to 200 mg/mL (about 6 to 20% (W/V)).

41. A blood-free, animal protein-free, plant-derived diet composition for feeding a hematophagous insect, the composition comprising hemp seed protein at a concentration of about 30 to 100 mg/mL (about 3 to 10% (W/V)) and spirulina protein at a concentration of about 30 to 100 mg/ml (about 3 to 10% (W/V)).

42. The diet composition of claim 40 or 41 further comprising sodium chloride at a concentration of about 0.005 to 1.0% (W/V) or at a concentration of about 10-190 mM, and/or sodium bicarbonate at a concentration of about 0.042 to 0.1% (W/V) or at a concentration of about 0.1 mM-200 mM.

43. The diet composition of claim 40 or 41 further comprising sugar at a concentration of about 0.1-5% (W/V) or at a concentration of about 3-150 mM.

44. A method of making an artificial, blood-free diet composition for feeding a hematophagous insect, the method comprising:
a) isolating protein from hemp seeds; and
b) adding sodium chloride and/or sodium bicarbonate to the isolated protein to make the diet composition.

45. The method of claim 44 further comprising isolating protein from spirulina.

46. The method of claim 44 or 45 further comprising isolating protein from another plant source.

47. The method of claim 44, 45, or 46 further comprising adding sugar to the composition.

48. The method of any one of claims 44-47, wherein the isolating protein from hemp seeds comprises extracting water-soluble protein from the hemp seeds and obtaining the hemp milk.

49. The method of claim 48, wherein the hemp protein is precipitated from the hemp milk.

50. The method of claim 47, wherein the sugar is a plant-derived sugar.

51. The method of any one of claims 46-50, wherein the protein is present in the composition at a concentration of about 60-200 mg/mL or about 6-20% (W/V).

52. The method of any one of claims 46-51, wherein the sodium chloride is present in the composition at a concentration of about 0.005-1.0% (W/V) or at a concentration of about 10-190 mM.

53. The method of any one of claims 46-52, wherein the sodium bicarbonate is present in the composition at a concentration of about 0.042 to 0.1% (W/V) or at a concentration of about 0.1-200 mM.

54. The method of any one of claims 46-53, wherein the sugar is present in the composition at a concentration of about 0.1-5% (W/V) or at a concentration of about 3-150 mM.

55. The method of any one of claims 46-54, wherein the method further comprises freeze drying the composition.
